(19) United States
(12) Patent Application Publication
(10) Pub. No.: US 2025/0128724 A1
(43) Pub. Date: Apr. 24, 2025

(54) SELF-DIAGNOSIS DEVICE FOR VEHICLE

(71) Applicant: TOYOTA JIDOSHA KABUSHIKI KAISHA, Toyota-shi (JP)

(72) Inventor: Takashi CHIBA, Gotemba-shi (JP)

(73) Assignee: TOYOTA JIDOSHA KABUSHIKI KAISHA, Toyota-shi (JP)

(21) Appl. No.: 18/675,315

(22) Filed: May 28, 2024

(30) Foreign Application Priority Data
Oct. 18, 2023 (JP) 2023-179816

(51) Int. Cl. B60W 50/14; B60W 50/02; B60W 50/12; G06V 20/58

(52) U.S. Cl. CPC B60W 50/14; B60W 50/0205; B60W 50/12; G06V 20/58; B60W 2050/021; B60W 2050/143; B60W 2050/146; B60W 2420/403; B60W 2420/408; B60W 2520/10; B60W 2554/20

(57) ABSTRACT

A self-diagnosis support device for a vehicle includes a camera for outputting information on an image obtained by shooting a predetermined area in vicinity of an own vehicle, a millimeter-wave radar device for outputting a relative velocity that is a velocity of a three-dimensional object with respect to the own vehicle, a vehicle speed sensor for outputting a vehicle speed of the vehicle, and a processor that identifies a stationary object in the vicinity of the own vehicle, acquires a relative velocity that is a velocity of the stationary object with respect to the own vehicle, acquires an absolute value of a component of relative velocity of the stationary object, as an actual vehicle speed of the own vehicle, further acquires the vehicle speed from the vehicle speed sensor, and when a threshold value of a duration time of a state is exceeded, controls a notification device.

### CROSS-REFERENCE TO RELATED APPLICATION

This application claims priority to Japanese Patent Application No. 2023-179816 filed on Oct. 18, 2023, incorporated herein by reference in its entirety.

### BACKGROUND

### 1. Technical Field

The disclosure relates to a self-diagnosis device for a vehicle, in which the self-diagnosis device is capable of performing notification that a vehicle speed (absolute value) of an own vehicle acquired based on revolutions per unit time of a wheel of the own vehicle is inaccurate.

### 2. Description of Related Art

Vehicle speed sensors for detecting the vehicle speed of the own vehicle are well known (e.g., see Japanese Unexamined Patent Application Publication No. 2009-236570 (JP 2009-236570 A)). This type of vehicle speed sensor acquires revolutions N of a wheel per unit time, and acquires and outputs a vehicle speed vs of the own vehicle by multiplying the rotational speed N by a dynamic rolling radius (coefficient k) of the wheel. This coefficient k is decided when the vehicle is shipped from the factory (when the vehicle is designed), and is stored in a storage device (read-only memory (ROM)) of the vehicle speed sensor. That is to say, the coefficient k is a fixed value (non-rewritable). Note that in a conventional vehicle, a value output from the vehicle speed sensor (vehicle speed vs) may be displayed on a display (speedometer) provided in an instrument panel of the vehicle. Also, control (driving assistance, automated driving) of the own vehicle may be executed based on the value output from the vehicle speed sensor (vehicle speed vs).

### SUMMARY

Now, the dynamic rolling radius of the wheel changes (increases or decreases) in accordance with tire air pressure. Also, when a user replaces the wheels of the own vehicle, the dynamic rolling radius may change. For example, when the outer diameter of the wheel after replacement is larger than the outer diameter of the wheel at the time of shipment of the own vehicle from the factory (when inch-up sizing is performed), the dynamic rolling radius is likely to increase. However, as described above, the coefficient k of the vehicle speed sensor is a fixed value. Accordingly, there are cases in which the difference (error) between the vehicle speed vs output from the vehicle speed sensor and actual vehicle speed vsa will be relatively great due to the change in the dynamic rolling radius of the wheels.

An object of the disclosure is to provide a self-diagnosis device for a vehicle, in which the self-diagnosis device is capable of performing notification that the vehicle speed of the own vehicle acquired based on revolutions per unit time of the wheel of the own vehicle is inaccurate.

In order to solve the above problem, a self-diagnosis device (1) for a vehicle, according to the disclosure, includes
a camera (22) that outputs information regarding an image obtained by shooting a predetermined region in a vicinity of an own vehicle,
a millimeter-wave radar device (23) that acquires and outputs a relative velocity that is a velocity of a three-dimensional object with respect to the own vehicle,
a vehicle speed sensor (21) that acquires and outputs a vehicle speed (vs) of the own vehicle, based on revolutions (N) per unit time of a wheel of the own vehicle, and
a processor (10) that identifies a stationary object (OB) in the vicinity of the own vehicle based on the information acquired from the camera, acquires a relative velocity (vr) that is a velocity of the stationary object with respect to the own vehicle from the millimeter-wave radar device, acquires an absolute value of a component of relative velocity of the stationary object that is a component in a direction parallel to a traveling direction of the own vehicle,
as an actual vehicle speed (vsa) of the own vehicle, further acquires the vehicle speed from the vehicle speed sensor, and when a threshold value (Δtth) of a duration time (Δt) of a state in which an absolute value (Δvs) of a difference between the vehicle speed and the actual vehicle speed is exceeding a threshold value (Δvsth) is exceeded, controls a notification device (30) such that predetermined information is provided to a driver.

Note that in the present specification, the term “velocity” is a concept including a direction in which an object is traveling, and also including speed (absolute value) thereof (vector). On the other hand, the terms “vehicle speed” and “actual vehicle speed” refer to the speed (absolute value) of the vehicle, and are concepts that do not include the direction in which the vehicle is travelling (scalar).

An absolute value (speed) of a component of relative velocity (vector) between a three-dimensional object (stationary object) fixed to the ground and the own vehicle, and that is parallel to the traveling direction of the own vehicle, matches the actual vehicle speed (absolute value) of the own vehicle. The processor of the self-diagnosis device for the vehicle according to the disclosure identifies the stationary object based on information acquired from the camera, and acquires, as the actual vehicle speed of the own vehicle, the absolute value of the component of relative velocity (vector) that is the velocity of the stationary object as viewed from the own vehicle, and that is a component parallel to the traveling direction of the own vehicle, based on the information acquired from the millimeter-wave radar device. Thus, the processor can acquire the actual vehicle speed of the own vehicle with high accuracy by using different means from the vehicle speed sensor. When the threshold value of the duration time of the state in which the absolute value of the difference between the vehicle speed acquired from the vehicle speed sensor and the actual vehicle speed is exceeding the threshold value is exceeded, it is highly likely that the current value of the dynamic rolling radius of the wheel as to a design value is excessively great or excessively small. Accordingly, in this case, the processor determines that the vehicle speed output from the vehicle speed sensor is inaccurate, and provides predetermined information (information indicating that the output of the vehicle speed sensor is inaccurate) to the driver. As described above, the self-diagnosis device for the vehicle, according to the disclosure, can detect that the vehicle speed of the own vehicle output from the vehicle speed sensor is inaccurate (reliability is low).

In the self-diagnosis device according to an aspect of the disclosure, when the threshold value of the duration time of the state in which the absolute value of the difference between the vehicle speed acquired from the vehicle speed sensor and the actual vehicle speed is exceeding the threshold value is exceeded the processor executes correction processing of correcting the vehicle speed output from the vehicle speed sensor, based on a ratio between the actual vehicle speed and the vehicle speed acquired from the vehicle speed sensor.

According to this configuration, other electronic control units (ECUs) with which the own vehicle is equipped (e.g., an ECU that executes driving assistance, an ECU that displays the vehicle speed on a display device provided in an instrument panel, and so forth) can execute various types of processing based on the vehicle speed that has been corrected (accurate value).

In the self-diagnosis device according to another aspect of the disclosure, when the threshold value of the duration time of the state in which the absolute value of the difference between the vehicle speed acquired from the vehicle speed sensor and the actual vehicle speed is exceeding the threshold value is exceeded, and also the driver of the own vehicle executes an operation to request correction of the vehicle speed, the processor executes the correction processing.

According to this configuration, the driver can select whether or not to correct the vehicle speed that is output from the vehicle speed sensor.

In the self-diagnosis device according to another aspect of the disclosure, when the threshold value of the duration time of the state in which the absolute value of the difference between the vehicle speed acquired from the vehicle speed sensor and the actual vehicle speed is exceeding the threshold value is exceeded, and also the driver of the own vehicle does not execute an operation to request correction of the vehicle speed, the processor controls the notification device to provide the driver with information regarding the wheel of the own vehicle without executing the correction processing.

For example, the processor causes the display device to display information (an image) regarding how to measure and adjust tire air pressure of the wheel, and how to replace the wheels, as information for prompting inspection of the wheels. Also, the processor causes the display device to display information regarding a repair shop at which the wheels of the own vehicle can be replaced, for example. By the driver or repair shop staff adjusting the air pressure of the wheels (tires) or replacing the wheels, the dynamic rolling radius will approximately match the design value, and the vehicle speed sensor will output an accurate vehicle speed.

In the self-diagnosis device according to another aspect of the disclosure, when the threshold value of the duration time of the state in which the absolute value of the difference between the vehicle speed acquired from the vehicle speed sensor and the actual vehicle speed is exceeding the threshold value is exceeded, and also the driver of the own vehicle does not execute an operation to request correction of the vehicle speed, the processor temporarily disables a driving assistance function that the own vehicle is equipped with, without executing the correction processing.

There are cases in which the control device (driving assistance ECU) that the own vehicle is equipped with is configured to execute driving assistance based on the vehicle speed output from the vehicle speed sensor. In vehicles designed in this way, when the vehicle speed output from the vehicle speed sensor is inaccurate, driving assistance May not be executed as intended by the designer. According to the disclosure, when determination is made that the output of the vehicle speed sensor is inaccurate, execution of driving assistance is forbidden. That is to say, driving assistance that differs from the intent of the designer is suppressed from being provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a self-diagnosis device for a vehicle according to an embodiment of the present disclosure;

FIG. 2 is a plan view illustrating a process of acquiring an actual vehicle speed;

FIG. 3 is a flow chart of a program executed by a CPU to implement a correcting function; and

FIG. 4 is a flow chart of a program executed by CPU to implement the diagnostic function and the correction-factor updating function.

### DETAILED DESCRIPTION OF EMBODIMENTS

### Overview

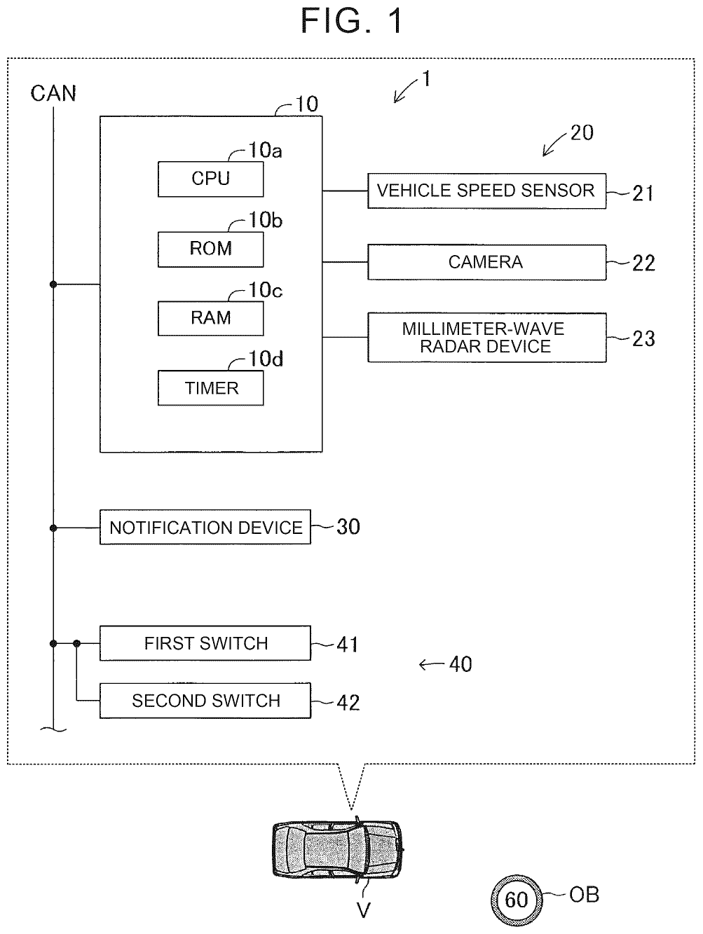

As illustrated in FIG. 1, the self-diagnosis device 1 for a vehicle according to an embodiment of the present disclosure is applied to a vehicle V (hereinafter, referred to as an “own vehicle”) having an automatic driving function. The vehicle self-diagnosis device 1 has a function (diagnosis function) of detecting and notifying that the vehicle speed vs of the own vehicle outputted from a vehicle speed sensor 21 to be described later is inaccurate, and a function (correction function) of correcting the vehicle speed vs when the vehicle speed vs is inaccurate.

### Specific Configuration

As illustrated in FIG. 1, the vehicle self-diagnosis device 1 includes a ECU 10, an in-vehicle sensor 20, a notification device 30, and an operation switch 40.

ECU 10 includes a microcomputer including a CPU 10a, ROM 10b (rewritable non-volatile memory), a RAM 10c, a timer 10d, and the like. CPU realizes various functions by executing a program (instruction) stored in ROM. ECU 10 is connected to another ECU via Controller Area Network (CAN). For example, the other ECU is a ECU for displaying various parameters (for example, the vehicle speed of the own vehicle, the engine speed, and the like) on a display device provided on an instrument panel in a ECU where the driving support is executed.

The in-vehicle sensor 20 includes a vehicle speed sensor 21, a camera 22, and a millimeter-wave radar device 23.

The vehicle speed sensor 21 includes a rotation speed measurement circuit and a vehicle speed calculation device. The rotation speed measurement circuit includes a pulse generation circuit that outputs a pulse (electric signal) every time a wheel of the own vehicle rotates by a predetermined angle, and a counter circuit that counts the number of the pulses. The vehicle speed calculation device acquires the output value (the number of pulses) of the counter circuit at a predetermined cycle (every time the unit time elapses), and resets the count value to “0”. In this way, the vehicle speed calculation device acquires the rotational speed N of the wheel per unit time. Then, the vehicle speed calculation device obtains the vehicle speed vs (absolute value) of the own vehicle by multiplying the rotational speed N by the coefficient k. The coefficient k is stored in a ROM included in the vehicle speed calculation device. That is, the coefficient k is a fixed value. The vehicle speed sensor 21 provides the vehicle speed vs to ECU 10.

The camera 22 includes an imaging device and an image analysis device. The imaging device incorporates, for example, a CCD. The imaging device is installed at a front portion of the own vehicle and is directed toward the front of the own vehicle. The imaging device shoots a foreground of the own vehicle at a predetermined frame rate, and acquires image data. The image analysis device can acquire image data from the imaging device, analyze the image data, recognize (identify) a target object existing in the angle of view, and acquire the position (relative position) of the target object with respect to the own vehicle based on the position (coordinates) of the target object in the image. For example, the image analysis device recognizes (identifies) a three-dimensional object (a stationary object OB (for example, a traffic sign)) installed (fixed) on the ground and acquires the position P (the position of the stationary object with respect to the own vehicle). The image analysis device provides the recognition result (the recognition result of the target and the position of the target with respect to the own vehicle) to ECU 10.

The millimeter-wave radar device 23 includes a transmission/reception unit and a signal processing unit (not shown). The transmission and reception unit radiates a millimeter-wave band radio wave (hereinafter, referred to as “millimeter wave”) toward the front of the own vehicle, and receives a millimeter wave (reflected wave) reflected by a three-dimensional object located within a radiation range. The signal processing unit acquires various kinds of information on each reflection point R of the millimeter wave based on a physical quantity such as a time from when the transmission/reception unit radiates the millimeter wave until when the reflected wave is received, an attenuation level of the reflected wave, and a difference between a frequency of the radiated millimeter wave and a frequency of the received reflected wave. For example, the signal-processing device calculates the position of the respective reflection points R (the relative position RP (direction/distance) with respect to the transmission/reception unit). In addition, the signal-processing unit calculates a relative velocity vr (vector) that is a velocity of the respective reflection points R with respect to the own vehicle. Then, the calculation result (data indicating the distribution of the reflection points R (data including the position RP and the relative velocity vr of the reflection points R)) is transmitted to ECU 10. The range in which the millimeter-wave radar device 23 can notify a three-dimensional object (the range in which the millimeter wave is radiated) is substantially the same as the angle of view (imaging range) of the camera 22.

The notification device 30 includes an image display device and an acoustic device. The image display device receives an image display command from ECU 10 and displays a predetermined image corresponding to the command. In addition, the sound device receives a sound reproduction command from ECU 10, and reproduces a predetermined sound corresponding to the command.

The operation switch 40 includes a first switch 41 that is operated when the driver requests to start diagnosis of a vehicle speed, which will be described later, and a second switch 42 that is operated when the driver requests to update the correction coefficient Δk. These switches are composed of, for example, push-button type switch devices. These switches are, for example, integrated into the spokes of the steering wheel. ECU 10 monitors the on/off status of these switches.

### Correction Function

When the ignition switch is in the ON state, ECU 10 acquires the vehicle speed vs from the vehicle speed sensor 21 at a predetermined cycle, and provides the vehicle speed vs obtained by multiplying the vehicle speed vs by the correcting factor Δk to another ECU. For example, another ECU is a ECU that causes a display device of an instrument panel to display a vehicle speed in a ECU where driving assistance such as adaptive cruise control (ACC) is executed. Here, the correction coefficient Δk is initialized to “1” at the time of factory pick-up of the own vehicle (that is, when the dynamic load radius of the wheel matches the design value or the error thereof is minute). As will be described later, when a predetermined operation is executed, the correction coefficient Δk is updated. The correction factor Δk is stored in ROM 10b (flash ROM). Therefore, even if the ignition switch is turned off, the correction coefficient Δk is maintained.

### Diagnostic Function

When detecting that the first switch 41 has been pushed in, ECU 10 acquires various kinds of information (information on the identified target and information on the reflection point R) from the camera 22 and the millimeter-wave radar device 23 at a predetermined cycle. In general, an image analysis apparatus of a camera can accurately identify each target (other vehicle, guard rail, sign, or the like) included in an image based on image data acquired from an imaging apparatus. However, the image-recognizing device cannot accurately acquire the speed (the velocity with respect to the own vehicle (the relative velocity vr)) of the respective targets. On the other hand, the signal-processing unit of the millimeter-wave radar device can accurately acquire the velocity of each target object (the speed (the relative velocity vr) of the target object with respect to the own vehicle). However, the signal processing unit cannot accurately identify each target. In the present embodiment, ECU 10 identifies (selects) the stationary object OB based on the information acquired from the camera 22, and acquires the velocity (relative velocity vr) of the stationary object OB with respect to the own vehicle based on the information acquired from the millimeter-wave radar device 23 (fusion process).

Specifically, ECU 10 associates a traffic sign (in the present embodiment, a sign indicating the restricted vehicle speed) as a stationary object OB with a reflection point R corresponding to the stationary object OB among the targets identified by the image-recognition device of the camera 22. The stationary object OB is usually a predetermined type of object as an object fixed to the ground. For example, ECU 10 acquires the position

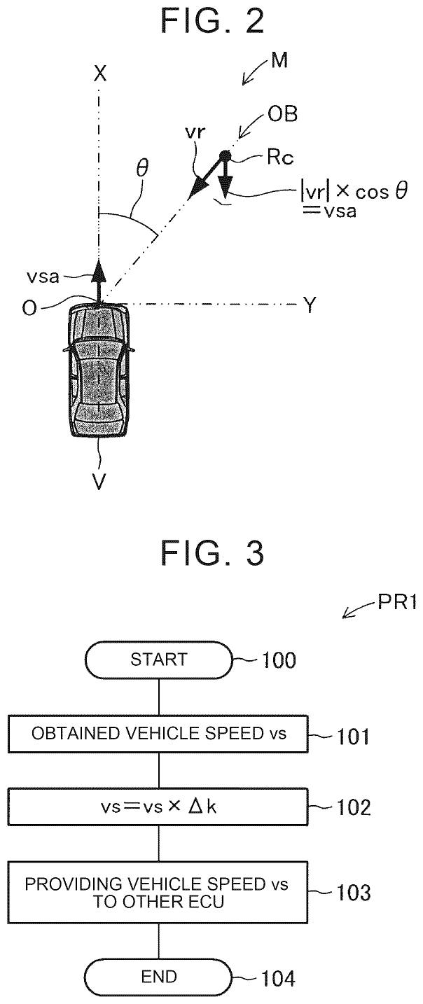

P of the selected stationary object OB from the camera 22. Then, ECU 10 selects a plurality of reflection points R from among the reflection points R acquired from the millimeter-wave radar device 23. The plurality of selected reflection points R are distributed such that the same position or distance as the position P (the position of the stationary object OB acquired from the image-recognizing device) is equal to or smaller than the threshold value, and the set (the reflection point group) is substantially circular (the shape of the sign representing the restricted vehicle speed). Then, ECU 10 selects a reflection point Rc located at the center of the plurality of selected reflection points R. ECU 10 obtains the relative velocity vr of the reflection point Rc from the signal-processing device of the millimeter-wave radar device 23 (see FIG. 2). Note that the map M shown in FIG. 2 is a X-Y coordinate plane in which the center portion in the vehicle width direction of the front end of the own vehicle in a plan view is set as the origin O, and its X axis is defined so as to coincide with the front-rear direction of the own vehicle, and its Y axis is defined so as to coincide with the vehicle width direction of the own vehicle. In the following explanation, the angle between the straight line connecting the origin O and the reflection point Rc and the X-axis is referred to as an “angle θ”.

Here, the absolute value of the X-axis component of the relative velocity vr corresponds to the actual vehicle speed vsa of the own vehicle. ECU 10 acquires the actual vehicle speed vsa based on the arithmetic expression (1) below.

vsa=|vr|×cos θ (1)

When the information acquired from the camera 22 includes information on a plurality of stationary object OB, ECU 10 selects one of the stationary object OB. For example, ECU 10 selects the stationary object OB closest to the own vehicle. However, ECU 10 may select a plurality of stationary object OB, calculate the actual vehicle speed vsa based on the relative velocity vr of the respective stationary object OB, and adopt the averages of the plurality of actual vehicle speed vsa as the actual vehicle speed vsa.

Next, ECU 10 acquires the vehicle speed vs from the vehicle speed sensor 21. ECU 10 calculates the absolute value (error Δvs) of the difference between the absolute value of the vehicle speed vs and the actual vehicle speed vsa. Next, ECU 10 determines whether or not the error Δvs exceeds the threshold Δvsth. ECU 10 uses the timer 10d to measure the duration Δt during which the error Δvs exceeds the threshold Δvsth (Δvs>Δvsth). If the time Δt exceeds the threshold Δtth, ECU 10 determines that the present dynamic-load-radius of the wheel is likely to be too large or too small relative to the design-value. That is, ECU 10 determines that the output of the vehicle speed sensor 21 is inaccurate. In this situation, ECU 10 causes the image display device of the notification device 30 to display an image indicating that the vehicle speed vs is inaccurate, and causes the sound device to reproduce a predetermined sound (beep).

On the other hand, if the error Δvs is less than or equal to the threshold Δvsth, ECU 10 determines that the present dynamic-load-radius of the wheel is likely to match the design-value. That is, ECU 10 determines that the output of the vehicle speed sensor 21 is accurate. In this situation, ECU 10 causes the image display device of the notification device 30 to display an image indicating that the output of the vehicle speed sensor is accurate, and causes the sound device to reproduce a predetermined sound. Further, if the error Δvs exceeds the threshold Δvsth and then the error Δvs becomes equal to or less than the threshold Δvsth before the time Δt reaches the threshold Δtth, it is highly likely that the dynamic load radius of the wheel temporarily (by a short time) fluctuates (increases or decreases with respect to the design value). Therefore, ECU 10 also causes the notification device 30 to present information (images and sounds) indicating that “the vehicle speed sensor is accurately outputted”.

### Correction Coefficient Update Function

As described above, ECU 10 notifies that the output (vehicle speed vs) of the vehicle speed sensor 21 is inaccurate. Thereafter, ECU 10 causes the image-display device to display an image used for executing an operation of approving the update of the correction factor Δk, and causes the sound device to reproduce a predetermined sound (update confirmation processing). When ECU 10 detects that the second switch 42 has been pushed in within a predetermined period after ts of the time point at which the update confirmation process is executed, it acquires (updates) the correction factor Δk on the basis of the arithmetic expression (2) below.

Δk=vsa/vs (2)

When the second switch 42 is not pushed in within a predetermined period after the time point ts, ECU 10 disables a predetermined driving assistance function (a function of controlling the own vehicle based on the vehicle speed vs) included in the own vehicle. In this situation, ECU 10 causes the image display device of the notification device 30 to display an image indicating that the predetermined driving assistance function is disabled.

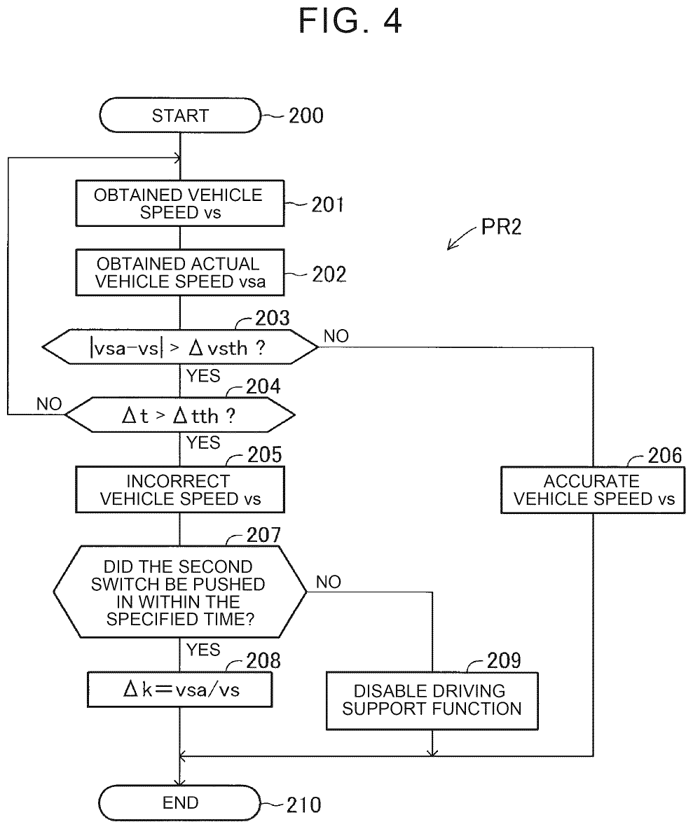

Next, referring to FIG. 3, a program PRI executed by a CPU 10a (hereinafter, simply referred to as “CPU”) in order to realize the above-described correcting function will be described. Further, referring to FIG. 4, a program PR2 executed by CPU to realize the diagnostic function and the correction-factor updating function will be described.

### Program PR1

CPU executes the program PR1 at a predetermined cycle when the ignition switch is in the on-state. CPU starts executing the program PRI from step 100, and advances the process to step 101.

In step 101, CPU acquires the vehicle speed vs from the vehicle speed sensor 21. CPU then proceeds to step 102.

CPU corrects the vehicle speed vs in step 102. That is, CPU obtains an accurate vehicle speed vs (corrected vehicle speed vs) by multiplying the vehicle speed vs by the correction factor Δk. CPU then proceeds to step 103. The correction coefficient Δk is initialized to “1” at the time of factory shipment. Further, as will be described later, in some cases, the correction factor Δk is updated in the process of CPU executing the program PR2 after being shipped from the factory.

CPU provides the corrected vehicle speed vs to the other ECU at step 103. CPU then proceeds to step 104 and ends executing the program PR1 in step 104.

### Program PR2

When CPU detects that the first switch 41 has been pushed in, it starts executing the program PR2 from step 200 and causes the timer 10d to start measuring the duration Δt. CPU then proceeds to step 201.

In step 201, CPU acquires the vehicle speed vs from the vehicle speed sensor 21. CPU then proceeds to step 202.

In step 202, CPU determines an actual vehicle speed vsa (=|vr|×cosθ) based on various types of information acquired from the camera 22 and the millimeter-wave radar device 23 is obtained. CPU then proceeds to step 203.

In step 203, CPU determines whether or not the error Δvs, which is the absolute value of the difference between the actual vehicle speed vsa and the vehicle speed vs, exceeds the threshold Δvsth. If CPU determines that the error Δvs exceeds the threshold Δvsth (203: Yes), the process proceeds to step 204. On the other hand, if CPU does not determine that the error Δvs exceeds the threshold Δvsth (203: No), the process proceeds to step 206.

In step 204, CPU determines whether or not the time Δt (the duration of the condition that the error Δvs exceeds the threshold Δvsth) exceeds the threshold Δtth. If CPU determines that the time Δt exceeds the threshold Δtth (204: Yes), the process proceeds to step 205. On the other hand, if CPU does not determine that the time Δt exceeds the threshold Δtth (204: No), the process returns to step 201.

In step 205, CPU causes the image display device to display an image indicating that the vehicle speed vs outputted from the vehicle speed sensor 21 is inaccurate, and causes the sound device to reproduce a predetermined sound. CPU then proceeds to step 207.

In step 206, CPU causes the display device to display images indicating that the vehicle speed vs outputted from the vehicle speed sensor 21 is accurate, and causes the sound device to reproduce predetermined sounds. CPU then proceeds to step 210 and ends executing the program PR2 in step 210.

In step 207, CPU causes the image display device to display an image used for executing an operation of starting updating the correction factor Δk. Further, CPU causes the sound device to reproduce a predetermined sound, and determines whether or not the second switch 42 is pushed in within a predetermined period thereafter. If CPU determines that the second switch 42 has been pushed in within the predetermined period (207: Yes), the process proceeds to step 208. On the other hand, if CPU does not determine that the second switch 42 has been pushed in within the predetermined period (207: No), the process proceeds to step 209.

CPU updates the correction factor Δk (=vsa/vs) in step 208. Then, CPU advances the process to step 210 and ends executing the program PR2.

In step 209, CPU disables the predetermined driving support function (prohibits the execution of the driving support). CPU then proceeds to step 210 to terminate executing the program PR2.

### Effect

An absolute value of a component that is a component of a relative velocity (vector) between a three-dimensional object (stationary object OB) fixed to the ground and the own vehicle and that is parallel to the traveling direction of the own vehicle corresponds to an actual vehicle speed of the own vehicle. ECU 10 identifies the stationary object OB based on the data acquired from the camera 22. Further, ECU 10 acquires the velocity vr between the stationary object OB and the own vehicle from the millimeter-wave radar device 23. Then, ECU 10 acquires the absolute value of the X-axis component of the relative velocity vr as the actual vehicle speed vsa of the own vehicle. Thus, ECU 10 can acquire the actual vehicle speed vsa of the own vehicle with high accuracy by using a unit different from the vehicle speed sensor 21. The absolute value of the difference between the vehicle speed vs and the actual vehicle speed vsa acquired from the vehicle speed sensor 21 is an error Δvs. If the duration Δt of the state in which the error Δvs exceeds the threshold Δvsth exceeds the threshold Δtth, it is determined that the current dynamic load radius of the wheel is likely to be too large or too small with respect to the design value. That is, ECU 10 determines that the vehicle speed vs output from the vehicle speed sensor 21 is inaccurate, and causes the notification device 30 to present predetermined information (information indicating that the output of the vehicle speed sensor 21 is inaccurate). As described above, the vehicle self-diagnosis device 1 can detect that the vehicle speed vs of the own vehicle outputted from the vehicle speed sensor 21 is inaccurate.

Further, ECU 10 updates the correction coefficient Δk when ECU 10 determines that the vehicle speed vs outputted from the vehicle speed sensor 21 is inaccurate and the driver requests to update the correction coefficient Δk. Thereafter, ECU 10 corrects the vehicle speed vs acquired from the vehicle speed sensor 21 using the updated correction factor Δk. Then, ECU 10 provides the corrected vehicle speed vs to another ECU. Other ECU included in the own vehicle (for example, in a ECU where driving assistance is executed, a ECU where a vehicle speed is displayed on a display device provided on an instrument panel, and the like) can execute various processes based on the corrected vehicle speed vs (accurate values).

If the driving assistance ECU included in the own vehicle is configured to execute the driving assistance (for example, ACC) based on the vehicle speed vs output from the vehicle speed sensor 21 and the vehicle speed vs output from the vehicle speed sensor 21 is inaccurate, the driving assistance (ACC) may not be executed as intended by the designer. ECU 10 of the vehicle self-diagnosis device 1 according to the present embodiment invalidates the driving assistance function (ACC) when it is determined that the vehicle speed vs outputted from the vehicle speed sensor 21 is inaccurate and when it is not required to update the correction factor Δk. As a result, it is possible to prevent driving assistance (ACC) that is not intended by the designer from being provided.

The present disclosure is not limited to the above-described embodiments, and various modifications can be adopted within the scope of the present disclosure as described below.

### Modification 1

The vehicle self-diagnosis device 1 may include only the above-described diagnosis function, and the correction function and the correction coefficient update function may be omitted.

### Modification 2

The self-diagnosis device 1 for a vehicle may include a device for detecting whether or not a wheel (tire) has been replaced. In this case, ECU 10 may automatically begin executing the program PR2 when it detects that the wheel has been replaced.

### Modification 3

If ECU 10 determines that the vehicle speed vs is inaccurate, it may cause the driver to display images on the display device that are used to select whether or not the wheels (tires) have been replaced. When the driver chooses to “replace the wheel (tire)” using a predetermined operating device, ECU 10 updates the correcting factor Δk.

### Modification 4

ECU 10 may cause the display device to display information about the wheel when the second switch 42 is not pushed in within a predetermined period of time from the time point ts. For example, when the vehicle speed vs is larger than the actual vehicle speed vsa, ECU 10 causes the image display device to display an image indicating that the air pressure of the wheel may be excessively large. Conversely, if the vehicle speed vs is less than the actual vehicle speed vsa, ECU 10 causes the image display device to display an image indicating that the air pressure of the wheel may be too low. Further, for example, ECU 10 displays, on the display device, information (images) regarding a method of measuring or adjusting the air pressure of the wheel and a method of replacing the wheel as information for prompting inspection of the wheel. Further, ECU 10 may cause the display device to display, for example, information about a repair shop in which the wheels of the own vehicle can be replaced. By adjusting the air pressure of the wheels (tires) or replacing the wheels, the driver or a person in charge in the repair shop can make the dynamic-load-radius substantially coincide with the designed value, and the vehicle speed sensor 21 outputs an accurate vehicle speed vs. When the driving assistance function is disabled, the disabled driving assistance function is enabled by executing a predetermined operation (transmitting a predetermined command from the external device to ECU 10) after the repair of the wheel is completed.

What is claimed is:

1. A self-diagnosis device for a vehicle, the self-diagnosis device comprising:
a camera that outputs information regarding an image obtained by shooting a predetermined region in a vicinity of an own vehicle;
a millimeter-wave radar device that acquires and outputs a relative velocity that is a velocity of a three-dimensional object with respect to the own vehicle;
a vehicle speed sensor that acquires and outputs a vehicle speed of the own vehicle, based on revolutions per unit time of a wheel of the own vehicle; and
a processor that identifies a stationary object in the vicinity of the own vehicle based on the information acquired from the camera, acquires a relative velocity that is a velocity of the stationary object with respect to the own vehicle from the millimeter-wave radar device, acquires an absolute value of a component of relative velocity of the stationary object that is a component in a direction parallel to a traveling direction of the own vehicle, as an actual vehicle speed of the own vehicle, further acquires the vehicle speed from the vehicle speed sensor, and when a threshold value of a duration time of a state in which an absolute value of a difference between the vehicle speed and the actual vehicle speed is exceeding a threshold value is exceeded, controls a notification device such that predetermined information is provided to a driver.

2. The self-diagnosis device according to claim 1, wherein, when the threshold value of the duration time of the state, in which the absolute value of the difference between the vehicle speed and the actual vehicle speed is exceeding the threshold value, is exceeded, the processor executes correction processing of correcting the vehicle speed output from the vehicle speed sensor, based on a ratio between the actual vehicle speed and the vehicle speed acquired from the vehicle speed sensor.

3. The self-diagnosis device according to claim 2, wherein, when the threshold value of the duration time of the state in which the absolute value of the difference between the vehicle speed acquired from the vehicle speed sensor and the actual vehicle speed is exceeding the threshold value is exceeded, and also the driver of the own vehicle executes an operation to request correction of the vehicle speed, the processor executes the correction processing.

4. The self-diagnosis device according to claim 2, wherein, when the threshold value of the duration time of the state in which the absolute value of the difference between the vehicle speed acquired from the vehicle speed sensor and the actual vehicle speed is exceeding the threshold value is exceeded, and also the driver of the own vehicle does not execute an operation to request correction of the vehicle speed, the processor controls the notification device to provide the driver with information regarding the wheel of the own vehicle without executing the correction processing.

5. The self-diagnosis device according to claim 2, wherein, when the threshold value of the duration time of the state in which the absolute value of the difference between the vehicle speed acquired from the vehicle speed sensor and the actual vehicle speed is exceeding the threshold value is exceeded, and also the driver of the own vehicle does not execute an operation to request correction of the vehicle speed, the processor temporarily disables a driving assistance function that the own vehicle is equipped with, without executing the correction processing.
